(19) United States
(12) Patent Application Publication
(10) Pub. No.: US 2026/0077773 A1
(43) Pub. Date: Mar. 19, 2026

(54) Detection of an Unknown and/or Undesirable Behavior of a Vehicle

(71) Applicants: Jeremias Hagel, Münster (DE); Cafer Ince, Ulm (DE)

(72) Inventors: Jeremias Hagel, Münster (DE); Cafer Ince, Ulm (DE)

(73) Assignee: Schmitz Cargobull AG, Altenberge (DE)

(21) Appl. No.: 19/317,796

(22) Filed: Sep. 3, 2025

(30) Foreign Application Priority Data
Sep. 13, 2024 (EP) 24200358.0

(51) Int. Cl. B60W 50/02; B60W 50/14; G07C 5/00

(52) U.S. Cl. CPC B60W 50/0205; B60W 50/14; G07C 5/008; B60W 2300/14

(57) ABSTRACT

A method performed by one or more servers that includes holding a digital representation of a vehicle and receiving a first sensor dataset including sensor data recorded by vehicle sensors. The first sensor dataset represents a first state of the vehicle. The method includes updating the digital representation of the vehicle based on the first sensor dataset to obtain an updated digital representation of the vehicle in the first state. The method includes detecting, based on the updated digital representation of the vehicle, an unknown and/or undesirable behavior of the vehicle and/or of one or more components of the vehicle. In response to detecting the unknown and/or undesirable behavior the method includes generating detection information to the effect that an unknown and/or undesirable behavior has been detected and/or generating a program code for detecting the unknown and/or undesirable behavior by way of a data processing unit of the vehicle.

### CROSS-REFERENCE TO RELATED PATENT APPLICATION

This patent application claims the benefit of priority to European Patent Application No. 24200358.0 filed Sep. 13, 2024, the entire teachings and disclosures are incorporated herein by reference thereto.

### FIELD

Exemplary embodiments of the invention relate to the detection of an unknown and/or undesirable behavior of a vehicle and/or of one or more components of the vehicle.

### BACKGROUND

The prior art discloses vehicles comprising a telematics unit, which transmit telematics datasets containing state information to a server with a certain regularity. If the telematics unit has detected a fault state of the vehicle, these pieces of state information may contain for example a fault code assigned to the detected fault state.

### SUMMARY OF A FEW EXEMPLARY EMBODIMENTS OF THE INVENTION

However, the detection of a fault state and the transmission of corresponding state information using the telematics units known from the prior art only works for known fault states. One object of the invention is therefore to overcome this disadvantage and to provide a solution that also makes it possible to detect unknown fault states.

Another object of the invention is to develop the prior art in an advantageous manner.

According to the invention, what is disclosed is a method, wherein the method is performed by one or more servers, and wherein the method comprises:
holding a digital representation of a vehicle;
receiving a first sensor dataset, wherein the first sensor dataset comprises sensor data that have been recorded by vehicle sensors of the vehicle, and wherein the first sensor dataset represents a first state of the vehicle;
updating the digital representation of the vehicle based on the first sensor dataset in order to obtain an updated digital representation of the vehicle in the first state;
detecting, based on the updated digital representation of the vehicle, an unknown and/or undesirable behavior of the vehicle and/or of one or more components of the vehicle;
in response to detecting the unknown and/or undesirable behavior:
generating detection information to the effect that an unknown and/or undesirable behavior has been detected; and/or
generating a program code for detecting the unknown and/or undesirable behavior by way of a data processing unit of the vehicle.

The disclosed method is performed by one or more servers. The fact that the disclosed method is performed by a server should be understood to mean that the server performs the method alone; that is to say the server, or means of the server, performs all of the steps of the method. And the fact that the disclosed method is performed by multiple servers should be understood to mean that the servers perform the method together; in other words, the servers, or means of the servers, cooperate to perform the method. By way of example, one server may perform one or more steps of the method, and another server may perform one or more other steps of the method. As an alternative or in addition, provision may also be made for two servers to cooperate to perform one or more steps of the method together. The multiple servers may be part of a cloud, as it is known.

What is accordingly also disclosed according to the invention is a server, wherein the server comprises means configured to perform the disclosed method. The means of the server are configured here to perform the method alone and/or in cooperation with one or more further servers. By way of example, the server is part of a cloud, as it is known.

The means may comprise hardware components and/or software components. The means may for example comprise at least one memory containing program instructions of a computer program (for example of the computer program disclosed below) and at least one processor designed to execute program instructions from the at least one memory. Accordingly, a server comprising at least one processor and at least one memory containing program instructions should also be understood to be disclosed, wherein the at least one memory and the program instructions are configured, together with the at least one processor, to cause the server to perform the disclosed method alone or in cooperation with one or more further servers. It goes without saying that the disclosed server may also comprise other means that have not been listed.

What is also disclosed is a system, wherein the system comprises at least the disclosed server and the vehicle. It goes without saying that the system may also comprise several of the disclosed servers, for example if these servers perform the disclosed method together.

The vehicle of the system is intended to be the vehicle whose vehicle sensors recorded the sensor data of the first sensor dataset. The vehicle may accordingly comprise vehicle sensors, for example. The vehicle may furthermore also comprise the data processing unit, for example.

What is also disclosed is a computer program, wherein the computer program comprises program instructions that are designed, when they are executed by at least one processor, to cause a server (for example the server disclosed above) to perform the disclosed method alone or in cooperation with one or more further servers.

The disclosed computer program is for example contained and/or stored on a computer-readable storage medium. A computer-readable storage medium should be understood to mean for example a physical and/or tangible storage medium.

The disclosed method, the disclosed server, the disclosed system and the disclosed computer program are used for example to detect an unknown and/or undesirable behavior of the vehicle and/or of one or more components of the vehicle.

In the following, the characteristics of the disclosed method (hereinafter also referred to as the “method”), the disclosed server (hereinafter also referred to as the “server”), the disclosed system (hereinafter also referred to as the “system”) and the disclosed computer program (hereinafter also referred to as the “computer program”) are described—in part by way of example. It goes without saying that the method, the server, the system and the computer program correspond to one another, and so the disclosure of a feature for one of these categories should be understood as the disclosure of a corresponding feature for the other categories.

Holding a digital representation of a vehicle should be understood to mean for example that such a digital representation is stored in a memory of one of the servers. By way of example, the digital representation may be stored permanently in the memory, for example if the memory is a non-volatile memory. As an alternative, it is also conceivable for the digital representation to be only buffered in the memory, for example if the memory is a volatile memory. In particular, the digital representation may be stored in a database in the memory, wherein the database stores a plurality of digital representations (for example one for each vehicle of a plurality of vehicles, such as a fleet of vehicles).

The digital representation of the vehicle is for example a digital model (for example a digital twin, as it is known) of the vehicle.

By way of example, the digital representation may represent the state (for example the basic state and/or the operating state) of the vehicle. By way of example, it is possible to hold, for each vehicle of a plurality of vehicles (for example of a fleet of vehicles belonging to a manufacturer or operator), such a digital representation of the respective vehicle.

The state of the vehicle may for example describe the state of the vehicle at a specific time. By way of example, the state of the vehicle may describe the basic state of the vehicle (for example at the specific time) and/or the operating state of the vehicle (for example at the specific time).

The basic state of the vehicle should be understood to mean for example a description (for example a representation) of (for example selected) characteristics of the vehicle that typically do not change during operation of the vehicle. Characteristics of the vehicle that typically do not change during operation of the vehicle are also referred to below as unchangeable characteristics. Such unchangeable characteristics are determined for example by the vehicle itself and/or the components installed in the vehicle. By way of example, the basic state may essentially describe the unchangeable characteristics of the vehicle resulting from the configuration and/or production of the vehicle. These are for example technical data concerning the vehicle (such as tank capacity, battery capacity, tire size and/or vehicle weight) and/or operating points of the vehicle (such as target battery voltage, maximum battery temperature, target tire pressure and/or maximum axle load).

The operating state of the vehicle should be understood to mean for example a description (for example a representation) of (for example selected) characteristics of the vehicle that typically change during operation of the vehicle. Characteristics of the vehicle that typically change during operation of the vehicle are also referred to below as changeable characteristics. Such changeable characteristics are determined for example by the use of the vehicle and/or the consumption of resources during operation of the vehicle. These are for example characteristics monitored by vehicle sensors during operation of the vehicle (such as tank fill level, battery voltage, battery temperature, tire pressure and/or axle load).

Accordingly, the first state of the vehicle describes for example the operating state and/or the basic state of the vehicle at the time when the first sensor dataset was recorded. The sensor data of the first sensor dataset may in particular represent the operating state of the vehicle at the time when the first sensor dataset was recorded. If the sensor data of the first sensor dataset were recorded at different times, for example, the time at which the last sensor data of the first sensor dataset were recorded and/or at which the first sensor dataset is received should be determined as the time at which the first sensor dataset was recorded.

The sensor data of a sensor dataset (such as the sensor data of the first sensor dataset and/or the sensor data of the second sensor dataset disclosed below and/or the sensor data of the training datasets disclosed below) are/were recorded by various sensors. The fact that sensor data of such a sensor dataset are/were recorded by sensors should be understood to mean for example that each of the sensors provides/provided respective sensor data and the respective sensor data represent (in quantitative and/or qualitative terms) a characteristic recorded by the respective sensor. In other words, the sensor data of a sensor dataset may represent (in quantitative and/or qualitative terms) characteristics recorded by various sensors. By way of example, each of the characteristics recorded by one of the sensors may be a physical or chemical quantity.

The various sensors are for example configured to record the characteristics with a certain regularity (for example at a certain frequency and/or at certain time intervals), wherein different regularities may be used for different sensors. The recorded sensor data may for example be collected and compiled with a certain regularity (for example at a certain frequency and/or at certain time intervals) so as to form a sensor dataset, such that the sensor data of a sensor dataset comprise for example only (for example all) sensor data that were collected after the previous sensor dataset was compiled. By way of example, the data processing unit of the vehicle receives the recorded sensor data from the various sensors, for example in order to collect them and compile them so as to form a sensor dataset and/or to process them further (for example in order to detect the unknown state).

Such sensor data may for example be collected by the vehicle and compiled as a sensor dataset. The sensor dataset may then be transmitted from the vehicle to at least one of the servers. By way of example, the sensor dataset is transmitted from the vehicle (for example in the case of the first sensor dataset and/or the second sensor dataset disclosed below) or one or more training vehicles (for example in the case of the training datasets disclosed below) to the at least one server via a communication path. Receiving a sensor dataset should accordingly be understood to mean that the sensor dataset is received by the at least one server via the communication path. By way of example, the communication path may (i) be wireless or (ii) comprise at least one wireless section, for example if the vehicle communicates wirelessly. It goes without saying that the communication path may also comprise at least one wired section, for example if the at least one server communicates in wired fashion. Examples of a wireless communication path and/or a wireless section of a communication path are a WLAN and/or mobile telephony connection. WLAN is for example specified in the standards of the IEEE 802.11 family and is currently available on the Internet at www.ieee.org. Mobile telephony should be understood to mean in particular mobile telephony communication systems such as a 2G/3G/4G/5G/6G communication system. The specifications of the 2G, 3G, 4G, 5G or 6G mobile telephony communication systems are currently developed by the 3rd Generation Partnership Project (3GPP) and are currently available on the Internet at https://www.3gpp.org/. Examples of a wired communication path and/or a wired section of a communication path are an Internet connection and/or an Ethernet connection. Ethernet is for example specified in the standards of the IEEE 802.3 family and is currently available on the Internet at www.ieee.org.

The vehicle sensors of the vehicle that record the sensor data of the first sensor dataset and/or the sensor data of the second sensor dataset disclosed below should be understood to mean for example regular vehicle sensors of the vehicle. In this context, regular vehicle sensors of the vehicle should be understood to mean for example vehicle sensors that have been installed as standard in the vehicle and/or that have also been/are also installed in comparable vehicles (for example in vehicles with the same basic state and/or with the same configuration), in particular in comparable sold vehicles. Such regular vehicle sensors are therefore different from additional sensors with which for example training vehicles are/have been equipped.

Updating the digital representation of the vehicle based on the first sensor dataset should be understood to mean for example that the operating state of the vehicle as represented by the digital representation of the vehicle is adapted according to the sensor data of the first sensor dataset. As a result of the update, an updated digital representation of the vehicle is then obtained, for example, representing the same operating state of the vehicle as the sensor data of the first sensor dataset. By way of example, the updated digital representation may contain the first sensor dataset.

The behavior of the vehicle describes for example the change in the operating state of the vehicle between a start time and an end time.

The fact that an unknown and/or undesirable behavior of the vehicle and/or of one or more components of the vehicle is detected based on the updated digital representation of the vehicle should be understood to mean for example that the updated digital representation of the vehicle is to be taken into account in the detection. However, it goes without saying that other pieces of information may also be taken into account in the detection as well.

The detection, based on the updated digital representation of the vehicle, of an unknown and/or undesirable behavior of the vehicle and/or of one or more components of the vehicle may be performed for example based on predetermined rules. By way of example, detecting an unknown and/or undesirable behavior of the vehicle and/or of one or more components of the vehicle may comprise determining the similarity and/or comparing the operating state represented by the updated digital representation of the vehicle with one or more known and/or desirable operating states. By way of example, the one or more known and/or desirable operating states may be predefined. By way of example, the one or more known and/or desirable operating states are defined at least partially by operating points of the vehicle (such as target battery voltage, maximum battery temperature, target tire pressure and/or maximum axle load), which are described by the digital representation of the vehicle. The rules may for example specify that, if the determination of similarity and/or the comparison reveals that the updated operating state does not correspond to any of the known and/or desirable operating states, an unknown and/or undesirable behavior is detected. As an alternative, the rules may also specify for example that an unknown and/or undesirable behavior is detected if the determination of similarity and/or the comparison reveals that the updated operating state is not similar to any of the known and/or desirable operating states (for example because (the/all) similarity measure(s) obtained as a result of the determination of similarity and/or the comparison exceed(s) a threshold value). The invention is not limited thereto, however. By way of example, the detection may also be performed based on the detection model disclosed in detail below.

In response to the detection of the unknown and/or undesirable behavior, (i) detection information to the effect that an unknown and/or undesirable behavior has been detected should be generated, and/or (ii) a program code for detecting the unknown and/or undesirable behavior should be generated by a data processing unit of the vehicle.

The detection information is for example user information used to inform a user that an unknown and/or undesirable behavior has been detected. As an alternative or in addition, however, provision may also be made for the detection information to serve as a basis for further processing (for example by at least one of the servers and/or by one or more other servers).

The program code for detecting the unknown and/or undesirable behavior by way of a data processing unit of the vehicle serves for example to enable the data processing unit of the vehicle to detect the unknown and/or undesirable behavior.

By way of example, the program code comprises instruction in a higher programming language such as C++ or Java and/or instructions able to be executed directly by the data processing unit of the vehicle. Instructions in a higher programming language are also referred to as source code and typically have to be compiled and/or interpreted so that they are able to be executed by the data processing unit of the vehicle. This is typically not required in the case of instructions that are able to be executed directly by the data processing unit of the vehicle, and are referred to as machine code. By way of example, the program code may comprise instructions of a computer program able to be executed by the data processing unit of the vehicle and/or of part of a computer program able to be executed by the data processing unit of the vehicle. The computer program may for example be a diagnostic program able to be executed by the data processing unit and/or part of the software of the data processing unit of the vehicle.

The invention thus provides a solution that makes it possible, for the first time, to detect an unknown and/or undesirable behavior (for example an unknown fault state) of a vehicle using one or more servers and to enable a data processing unit of the vehicle to detect this behavior (for example this fault state) in the future, including on its own.

Further advantages of the disclosed invention are described below with reference to exemplary embodiments of the disclosed method, the disclosed server, the disclosed system and the disclosed computer program.

In exemplary embodiments, the method furthermore comprises at least one of the following steps:
outputting or causing the output of the detection information to a user (for example a user associated with the vehicle);
providing the detection information for output to a user (for example a user associated with the vehicle);
outputting and/or providing the detection information for further processing;
transmitting the program code to the vehicle and/or to a plurality of vehicles;
providing the program code for retrieval by the vehicle and/or a plurality of vehicles.

As disclosed above, the detection information may be user information used to inform a user that an unknown and/or undesirable behavior has been detected. Outputting such detection information in the form of user information should be understood to mean for example that said information is output by output means such as a screen and/or a loudspeaker. By way of example, the detection information may be displayed as text and/or graphics on a screen and/or played back as voice information through a speaker.

By way of example, at least one of the servers may output the detection information. As an alternative or in addition, the detection information may also be output by another device (for example a device different from the servers), such as a user device. For this purpose, causing the output of the detection information may comprise transmitting the detection information to the other device; and/or providing the detection information for the purpose of outputting the detection information may be performed such that the other device is able to retrieve the detection information. The detection information may be transmitted and/or retrieved via a communication path. The communication path for transmitting and/or retrieving the detection information may for example (i) be wired or (iii) comprise at least one wired section, for example if the at least one server communicates in wired fashion. It goes without saying that the communication path may also comprise at least one wireless section, for example if the other device communicates wirelessly.

By way of example, the user may be a user associated with the vehicle, such as the driver of the vehicle and/or the owner of the vehicle and/or a vehicle supervisor (for example a fleet supervisor responsible for the vehicle). The method may also accordingly comprise determining a user associated with the vehicle. Such a user associated with the vehicle may for example be stored in a database (for example a database of an ERP system (Enterprise Resource Planning System)), and so the determination may comprise querying a user associated with the vehicle in the database. As a result of the query, for example, it is possible to obtain contact information for transmitting the detection information to a user device of the user and/or for providing the detection information for retrieval by a user device of the user.

Furthermore, the detection information may also serve as a basis for further processing (for example data processing, for example by a computer program that receives the detection information as input data). By way of example, the detection information may be further processed by at least one of the servers and/or by another device (for example a device different from the servers). By way of example, the detection information is for this purpose output, for example transmitted, and/or provided to the at least one server and/or the other device, for example provided for retrieval in such a way that it is able to be retrieved by the at least one server and/or the other device. The detection information may be transmitted and/or retrieved via a communication path, as disclosed above.

As an alternative or in addition, the program code may be transmitted to the vehicle and/or to a plurality of vehicles and/or be provided in such a way that it is able to be retrieved by the vehicle and/or a plurality of vehicles. By way of example, at least one of the servers may transmit the program code and/or provide it for retrieval. The program code may be transmitted and/or retrieved via a communication path. The communication path for transmitting and/or retrieving the program code may for example (i) be wireless or (ii) comprise at least one wireless section, for example if the one or more vehicles communicate wirelessly. It goes without saying that the communication path for transmitting and/or retrieving the program code may also comprise at least one wired section, for example if the at least one server communicates in wired fashion.

The program code may for example be transmitted and/or provided in the form of an update (for example an update for software of the data processing unit of the vehicle and/or the plurality of vehicles).

The plurality of vehicles may comprise vehicles having the same basic state and/or the same configuration as the vehicle. The method may accordingly also comprise determining the plurality of vehicles. The plurality of vehicles may for example be stored in a database (for example a database of an ERP system (Enterprise Resource Planning System)), and so the determination may comprise querying the plurality of vehicles in the database. As a result of the query, for example, it is possible to obtain contact information for transmitting the program code to the plurality of vehicles and/or for providing the program code for retrieval by the plurality of vehicles.

In exemplary embodiments, the first sensor dataset and/or the second sensor dataset disclosed below comprises at least sensor data from one or more vehicle sensors of the following vehicle sensor types:
temperature sensor;
battery sensor;
voltage sensor;
current sensor;
door sensor;
tank fill level sensor;
tire pressure sensor;
weight sensor.

The vehicle may accordingly comprise at least one or more of these vehicle sensors.

The first sensor dataset and the second sensor dataset preferably comprise sensor data from the same vehicle sensors. However, it is also conceivable for the sensor data of the first sensor dataset and the sensor data of the second sensor dataset to originate at least partially from different vehicle sensors.

In exemplary embodiments, the vehicle sensors may at least partially be part of an electronic braking system and/or of a transport refrigeration machine of the vehicle.

In exemplary embodiments, the unknown and/or undesirable behavior is detected based on a detection model obtained by machine learning. The detection model is for example an artificial neural network, for example an artificial neural network having at least three layers, including the input layer and the output layer. Examples of an artificial neural network are neural networks having a feedforward architecture, multilayer perceptrons, convolutional neural networks and/or recurrent neural networks.

By way of example, the detection model is trained as part of supervised learning. In supervised learning, the detection model is trained, for example with training datasets, with it being specified, for each training dataset, whether an unknown and/or undesirable behavior (or a known behavior) is to be detected for the respective training dataset. This makes sense for example if the respective training dataset is associated with a known behavior, for example because the respective training dataset was recorded when the respective vehicle was in a known fault state. By way of example, in such a case, it may be specified, for the respective training dataset, that the known fault state is to be detected.

It goes without saying that the detection model may, as an alternative or in addition, be trained as part of unsupervised learning. In unsupervised learning, the detection model is trained, for example with training datasets, without it being specified, for each training dataset, whether an unknown and/or undesirable behavior (or a known behavior) is to be detected for the respective training dataset.

It goes without saying, however, that the invention is not limited thereto.

By way of example, the method furthermore comprises:
training the detection model with training datasets.

By way of example, each of the training datasets comprises respective sensor data that were recorded by one or more of the vehicle sensors and/or by one or more additional sensors of a training vehicle, each of the training datasets representing a respective state of the respective training vehicle. In other words, at least some of the sensor data of each of the training datasets are recorded by one or more of the vehicle sensors disclosed above (for example regular vehicle sensors); and/or at least some of the sensor data of each of the training datasets are recorded by one or more additional sensors.

As explained above, the vehicle sensors disclosed above may be regular vehicle sensors that have for example been installed as standard in the vehicle and/or that have also been/are also installed in comparable vehicles (for example in vehicles with the same basic state and/or with the same configuration), in particular in comparable sold vehicles. Such regular vehicle sensors are therefore different from additional sensors with which for example training vehicles may be equipped in addition to the vehicle sensors.

By way of example, at least one of the training datasets comprises at least sensor data from one or more additional sensors different from the vehicle sensors. This should be understood to mean that the additional sensors (for example in whole or in part) may correspond to the same vehicle sensor types as the vehicle sensors, as long as they are not the same sensors. By way of example, at least one of the vehicle sensors may be a voltage sensor and an additional sensor, different therefrom, may likewise be a voltage sensor.

However, at least some of the additional sensors may also correspond to other sensor types, such as for example strain gages and/or (for example additional and/or external) telemetry units (for example having one or more sensors and a memory for buffering the sensor data recorded by the sensors while driving).

It goes without saying that the training datasets may originate from one training vehicle or from multiple training vehicles. Each of the training vehicles may comprise (i) one or more of the additional sensors and/or (ii) one or more of the vehicle sensors disclosed above. By way of example, each of the training vehicles may comprise one or more further additional sensors in addition to the above-disclosed vehicle sensors of the vehicle.

In addition, it may be specified, for each of the training datasets as disclosed above, whether an unknown and/or undesirable behavior (or for example a known behavior) should be detected for the respective training dataset. By way of example, it is specified, for a training dataset, that an unknown and/or undesirable behavior should not be detected for it if it represents an expected operating state and/or a known fault state of the respective training vehicle; whereas it is specified, for a training dataset, that an unknown and/or undesirable behavior should be detected for it if it represents an unexpected operating state of the respective training vehicle.

The detection model may be part of a plurality of detection models. By way of example, a detection model is trained only for vehicles having the same basic state and/or the same vehicle configuration. Accordingly, the training datasets for training the detection model may originate from one or more training vehicles having the same basic state and/or the same vehicle configuration as the vehicle.

In exemplary embodiments, the detection model receives the updated digital representation of the vehicle (for example the first sensor dataset contained therein) as input data.

In exemplary embodiments, the detection model outputs a representation of the unknown and/or undesirable behavior.

By way of example, the detection model outputs a representation of sensor datasets that are associated with the unknown and/or undesirable behavior in the detection model. In this case, a sensor dataset should be understood as being associated with the unknown and/or undesirable behavior in the detection model when the detection model detects the undesirable behavior for a digital representation of the vehicle updated based on this sensor dataset.

As an alternative or in addition, the detection model may output a classification of the unknown and/or undesirable behavior. Such a classification may be for example a fault classification such as a system fault or a component fault (for example battery fault, engine control unit fault, tire fault, transmission fault, etc.).

By way of example, the generation of the program code is based on an output from the detection model. By way of example, the detection model may output at least part of the program code or a representation of at least part of the program code. By way of example, the detection model may output instructions in a higher programming language such as C++ or Java. These instructions in the higher programming language may represent the program code or part of the program code in the form of a source code. These instructions may then be combined and/or compiled with other instructions in the higher programming language as part of generating the program code, in order to generate the program code in the form of machine code. As disclosed above, the program code may comprise instructions of a computer program able to be executed by the data processing unit of the vehicle and/or of part of a computer program able to be executed by the data processing unit of the vehicle. The computer program may for example be a diagnostic program able to be executed by the data processing unit and/or part of the software of the data processing unit of the vehicle. The program code may for example be transmitted and/or provided in the form of an update (for example an update for software of the data processing unit of the vehicle and/or the plurality of vehicles).

By way of example, the detection information is based on an output from the detection model. By way of example, the detection information may be determined based on an output from the detection model, such as the classification of the unknown and/or undesirable behavior. As an alternative and/or in addition, the detection model may output at least part of the detection information or a representation of at least part of the detection information.

In exemplary embodiments, the program code is configured to cause the data processing unit of the vehicle to detect the unknown state based on sensor data recorded by vehicle sensors of the vehicle. By way of example, the program code is configured to cause the data processing unit of the vehicle to detect the unknown state at least when the data processing unit executes the program code and receives a second sensor dataset, wherein the second sensor dataset comprises sensor data that were recorded by vehicle sensors of the vehicle, and wherein the sensor data of the second sensor dataset correspond at least substantially to the sensor data of the first dataset.

The fact that the sensor data of the second sensor dataset correspond at least substantially to the sensor data of the first dataset is intended to cover in particular the case where the sensor data of the second sensor dataset are identical to the sensor data of the first dataset. Furthermore, this wording is also intended to be understood as covering cases where there are deviations between the sensor data of the second sensor dataset and the sensor data of the first sensor dataset, these deviations not being significant for the detection. Such deviations may occur for example due to measurement inaccuracies (for example within a predetermined tolerance range) and/or because some of the sensor data of the second sensor dataset were recorded by other (for example additional and/or fewer) vehicle sensors than the sensor data of the first sensor dataset.

The fact that the data processing unit executes the program code should be understood to mean for example that the program code is located in a memory of the data processing unit and at least one processor of the data processing unit executes instructions of the program code that cause the data processing unit to detect the unknown state at least when the data processing unit receives the second sensor dataset. In this case, the second sensor dataset may be received by the data processing unit in the form of the sensor data recorded by the vehicle sensors of the vehicle.

In exemplary embodiments, the unknown and/or undesirable behavior is associated with an unknown fault state of the vehicle and/or of the one or more components of the vehicle. Such an unknown fault state of the vehicle is for example an operating state of the vehicle that is not known and is not desirable. The fact that the unknown and/or undesirable behavior is associated with such an unknown fault state should be understood to mean for example that the updated digital representation of the vehicle represents such a state.

In exemplary embodiments, the method furthermore comprises:
assigning a fault code to the unknown and/or undesirable behavior, in particular when it is associated with an unknown fault state of the vehicle and/or of the one or more components of the vehicle.

This makes it possible for example to identify the unknown and/or undesirable behavior when it is detected again. By way of example, the data processing unit of the vehicle, when it detects the unknown and/or undesirable behavior, may transmit a corresponding fault code to one of the servers.

In exemplary embodiments, the vehicle is a utility vehicle trailer.

A utility vehicle trailer is for example a trailer for a truck, such as a rigid drawbar trailer or an articulated drawbar trailer or a semitrailer. Such utility vehicle trailers are intended in particular for transporting goods, preferably piece goods, in public road transport. For this purpose, utility vehicle trailers have different types of utility vehicle bodies, which serve for receiving the goods to be transported in a loading space. Known for example are box bodies with fixed side walls, a fixed front wall, a rear wall formed by wing doors and a fixed roof, which enclose the loading space. Since the box bodies are closed, box bodies are particularly suitable for the transport of moisture-sensitive and/or temperature-sensitive goods, that is to say for example for so-called dry transport and/or refrigerated transport. In addition to box bodies, also known are so-called tarpaulin bodies, in which the side walls and the roof are closed by at least one tarpaulin. In the case of tarpaulin bodies, the front wall is usually formed as a fixed wall, while the rear wall is regularly formed by two wing doors in order if required to load the loading space from the rear. If a tarpaulin can be moved along the side wall, they may also be referred to as curtainsiders. Accordingly, a utility vehicle body should be understood as meaning for example a box body, a tarpaulin body and/or a curtainsider.

In exemplary embodiments, the data processing unit of the vehicle is a telematics unit. Accordingly, the first sensor dataset may be a telematics dataset generated by the telematics unit and/or part of a telematics dataset generated by the telematics unit. Likewise, the second sensor dataset may also be a telematics dataset generated by the telematics unit and/or part of a telematics dataset generated by the telematics unit.

By way of example, the telematics unit of the vehicle receives sensor data recorded by the vehicle sensors. By way of example, the telematics unit of the vehicle is configured to collect the received sensor data (for example to buffer them in a memory) and to compile them with a certain regularity (for example at a certain frequency and/or at certain time intervals) in a telematics dataset and then to transmit the telematics dataset to the at least one of the servers (for example a telematics server) via the communication path.

Such a telematics dataset may also contain further pieces of information such as a fault code. If the telematics unit of the vehicle detects an unknown and/or undesirable behavior based on sensor data recorded by vehicle sensors of the vehicle, the telematics dataset may for example also contain, in addition to the sensor data, a fault code assigned to the unknown and/or undesirable behavior.

The training datasets may also be transmitted to the at least one server by corresponding telematics units of the training vehicles as respective telematics datasets via a respective communication path. As an alternative or in addition, it may also be the case that at least some of the sensor data of a training dataset are buffered while the respective training vehicle is being driven and are then able to read out via a wired connection, for example.

Further advantageous exemplary embodiments of the invention may be taken from the following detailed description of some exemplary embodiments of the present invention, in particular in conjunction with the figures. The figures are however only intended for the purpose of illustration, but do not serve for determining the scope of protection of the invention. The figures are not necessarily true to scale and are merely intended to reflect the general concept of the present invention by way of example. In particular, features contained in the figures are in no way intended to be considered a necessary part of the present invention.

### BRIEF DESCRIPTION OF THE DRAWINGS

In the figures:

FIG. 1 shows a schematic illustration of one exemplary embodiment of a system according to the invention;

FIG. 2 shows a schematic illustration of one exemplary embodiment of a server according to the invention;

FIG. 3 shows a schematic illustration of one exemplary embodiment of a data processing unit for a vehicle according to the invention;

FIG. 4 shows a flowchart of one exemplary embodiment of a method according to the invention.

### DETAILED DESCRIPTION OF SOME EXEMPLARY EMBODIMENTS

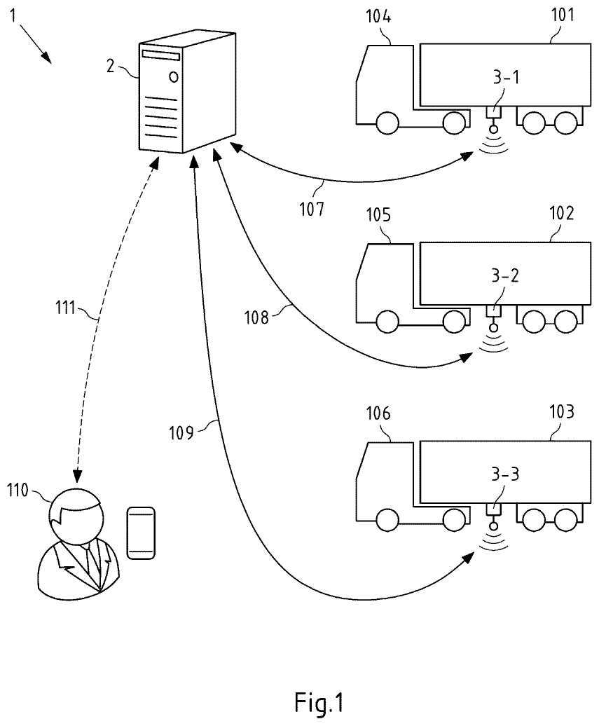

FIG. 1 shows a schematic illustration of one exemplary embodiment of a system according to the invention.

The system 1 comprises, inter alia, a plurality of vehicles 101 to 103. The vehicles 101 to 103 are illustrated in FIG. 1, by way of example, as semitrailers that are towed by one of the respective tractor units 104 to 106. The system 1 furthermore comprises a server 2 remote from the semitrailers 101 to 103 and the tractor units 104 to 106. It goes without saying that the system could also comprise multiple servers 2 and/or a cloud. However, it will be assumed by way of example below that the system comprises only the server 2.

FIG. 1 illustrates respective communication paths 107 to 109 between the semitrailers 101 to 103 and the server 2. The semitrailer 101 and the server 2 are able to exchange (for example transmit and receive) pieces of information (for example telematics datasets and/or software updates) via the communication path 107. In the same way, the semitrailers 102 and 103 and the server 2 are able to exchange (for example transmit and receive) pieces of information (for example telematics datasets and/or software updates) via the respective communication paths 108 and 109. By way of example, each of the semitrailers 101 to 103 comprises a respective telematics unit 3 (see 3-1, 3-2 and 3-3) that is configured to exchange pieces of information with the server 2 via the respective communication path.

It will be assumed by way of example below that each of the communication paths 107 to 109 comprises a respective wireless connection, such as a WLAN and/or mobile telephony connection.

It goes without saying that each of the communication paths 107 to 109 may also comprise, in addition to the wireless connection, a wired connection via a wired communication network such as an Ethernet network and/or the Internet. The exchange of information via the communication paths 107 to 109 may be encrypted.

FIG. 1 additionally illustrates a user device 110 of a user, such as a fleet supervisor, as an option. By way of example, the semitrailers 101, 102 and 103 belong to a fleet supervised by the user 110. The server 2 is able to communicate with the user device 110 of the user via the optional communication path 111.

The telematics units 3-1, 3-2 and 3-3 of the semitrailers 101 to 103 transmit telematics datasets to the server 2 via the communication paths 107 to 109 with a certain regularity (for example at a certain frequency and/or at certain time intervals). By way of example, the server 2 is able to transmit software updates to the telematics units 3-1, 3-2 and 3-3 of the semitrailers 101 to 103 via the communication paths 107 to 109. Furthermore, the server 2 is able to transmit user information to the user device 110 via the communication path 111.

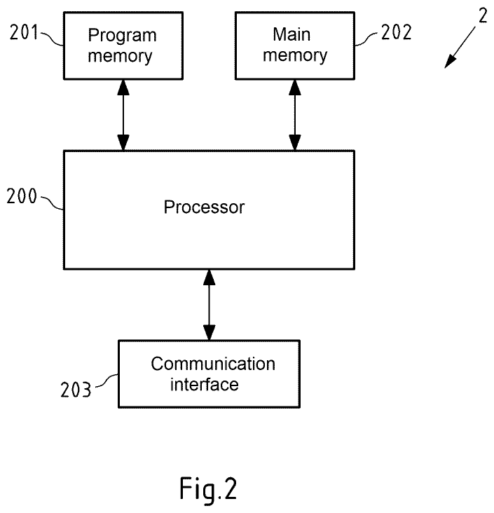

FIG. 2 shows a schematic illustration of one embodiment of a server 2 according to the invention. It will be assumed by way of example below that the server 2 of the system 1 illustrated in FIG. 1 corresponds to this server 2 illustrated in FIG. 2.

The server 2 comprises a processor 200 and, connected to the processor 200, a first memory as program memory 201, a second memory as main memory 202 and a network interface 203.

A processor should be understood to mean for example a microprocessor (central processing unit, CPU), a microcontroller unit, a microcontroller, a digital signal processor (DSP), an application-specific integrated circuit (ASIC), a field-programmable gate array (FPGA), or a graphics processor (graphics processing unit, GPU). It goes without saying that the server device 2 may also comprise multiple processors 200.

The processor 200 executes instructions stored in the program memory 201, and stores for example intermediate results or the like in the main memory 202. The use of an (additional) graphics processor may be advantageous for example for executing machine learning algorithms and/or artificial neural networks.

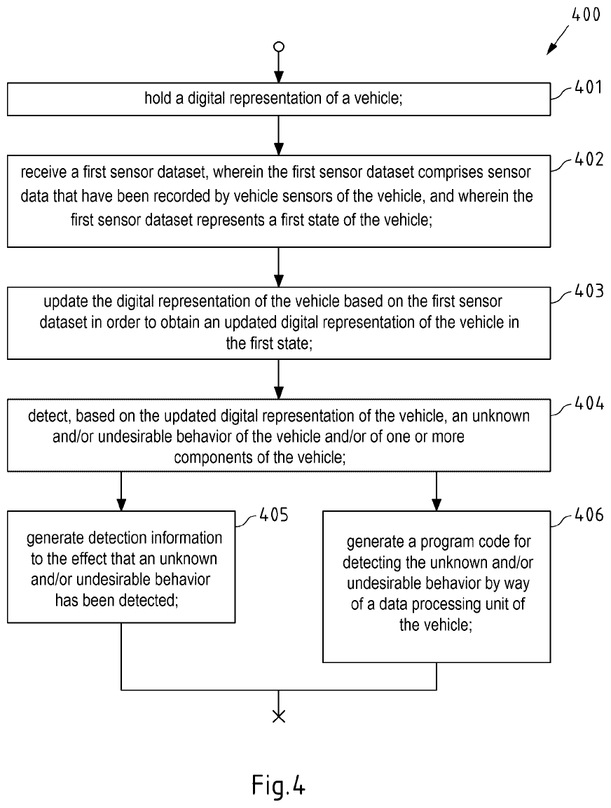

The program memory 201 stores for example instructions that cause the processor 200, when it executes the program instructions, to at least partially perform the method according to the invention (for example the method according to the flowchart 4 illustrated in FIG. 4). It will also be assumed below that the program memory 201 stores a detection model in the form of an artificial neural network that is trained by machine learning and is able to be used during the method according to the invention to detect an unknown and/or undesirable behavior of a semitrailer and/or of one or more components of the semitrailer.

In addition, the program memory 201 contains a respective digital representation for each of the semitrailers 101, 102 and 103 of the system 1 illustrated in FIG. 1.

The program memory 201 also contains for example the operating system of the server 2, which is at least partially loaded into the main memory 202 and executed by the processor 200 when the server 2 is booted. In particular, when the server 2 is booted, at least part of the core of the operating system is loaded into the main memory 202 and executed by the processor 200.

One example of an operating system is a Windows, UNIX, Linux, Android, Apple iOS and/or MAC OS operating system. The operating system allows in particular the server 2 to be used for data processing. It manages for example resources such as a main memory and a program memory, provides other computer programs with fundamental functions, inter alia through programming interfaces, and controls the execution of computer programs.

A program memory is for example a non-volatile memory such as a flash memory, a magnetic memory, an EEPROM memory (electrically erasable programmable read-only memory) and/or an optical memory. A main memory is for example a volatile or non-volatile memory, in particular a random access memory (RAM) such as a static RAM memory (SRAM), a dynamic RAM memory (DRAM), a ferroelectric RAM memory (FeRAM) and/or a magnetic RAM memory (MRAM).

The main memory 202 and the program memory 201 may also be in the form of one memory. As an alternative, the main memory 202 and/or the program memory 201 may each be formed by multiple memories. Furthermore, the main memory 202 and/or the program memory 201 may also be part of the processor 200.

The processor 200 controls the communication interface 203, which is configured for example to exchange (for example transmit and/or receive) pieces of information with a remote device via a connection in a communication network. It will be assumed by way of example below that the communication interface 203 is a wired communication interface. One example of a wired communication interface is an Ethernet interface. As disclosed above, Ethernet is specified for example in the standards of the IEEE 802.3 family. By way of example, the server 2 may use the communication interface 203 to exchange (for example transmit and/or receive) pieces of information (for example telematics datasets and/or software updates and/or pieces of user information) with the semitrailers 101 to 103 and the user device 110 of the system 1 illustrated in FIG. 1 via the communication paths 107 to 109 and 111.

The components 200 to 203 of the server 2 are for example communicatively and/or operatively connected to one another via one or more bus systems (for example one or more serial and/or parallel bus connections).

It goes without saying that the server 2 may comprise further components (for example a user interface) in addition to the components 200 to 203.

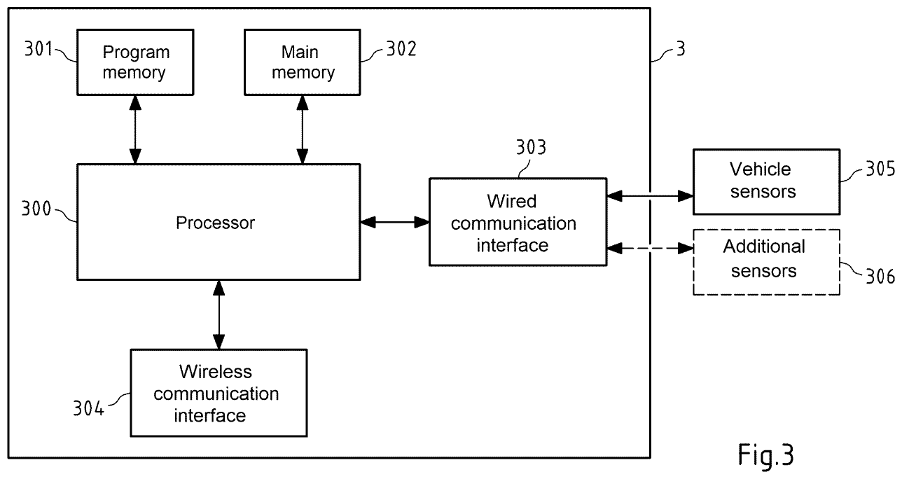

FIG. 3 shows a schematic illustration of one exemplary embodiment of a data processing unit 3 for a vehicle according to the invention. It will be assumed by way of example below that the data processing unit 3 is a telematics unit and the telematics units 3-1, 3-2 and 3-3 of the semitrailers 101, 102 and 103 of the system 1 illustrated in FIG. 1 correspond to this telematics unit 3 illustrated in FIG. 3.

The telematics unit 3 comprises a processor 300 and, connected to the processor 300, a first memory as program memory 301, a second memory as main memory 302, and a wired communication interface 303 and a wireless communication interface 304.

The processor 300 executes instructions stored in the program memory 301, and stores for example intermediate results or the like in the main memory 302. It goes without saying that the telematics unit 3 may also comprise multiple processors 100.

The program memory 301 stores for example the operating system of the telematics unit 3, which is at least partially loaded into the main memory 302 and executed by the processor 300 when the telematics unit 3 is started. In particular, when the telematics unit 3 is started, at least part of the core of the operating system is loaded into the main memory 302 and executed by the processor 300.

As disclosed in detail above, one example of an operating system is a Windows, UNIX, Linux, Android, Apple iOS and/or MAC OS operating system. The operating system allows in particular the telematics unit 3 to be used for data processing.

In addition to the operating system of the telematics unit 3, the program memory 301 may also contain further instructions. Examples of such instructions are for example instructions of a computer program, such as a telematics program and/or a diagnostic program. The instructions of the telematics program cause the processor 300, when it executes the instructions, for example, to buffer sensor data received via the wired communication interface 303 (for example in the program memory 301 and/or main memory 302) and to transmit a telematics dataset, containing the sensor data that were received after the previous telematics dataset was transmitted, to the server 2 via the wireless communication interface 304 with a certain regularity (for example at a certain frequency and/or at certain time intervals). In addition to the sensor data, the respective telematics dataset may also contain further pieces of information (for example pieces of state information and/or fault codes). The instructions of the diagnostic program cause the processor 300, when it executes the instructions, for example, to detect an unknown and/or undesirable behavior based on sensor data received via the wired communication interface 303 and to output a corresponding fault code.

It goes without saying that the telematics program and the diagnostic program may also be functions of a common computer program. As an alternative, the functions of the telematics program and of the diagnostic program may be distributed among multiple computer programs.

The main memory 302 and the program memory 301 may also be in the form of one memory. As an alternative, the main memory 302 and/or the program memory 301 may each be formed by multiple memories. Furthermore, the main memory 302 and/or the program memory 301 may also be part of the processor 100.

The processor 300 controls the wired communication interface 303, which is for example configured to exchange (for example transmit and/or receive) information with other components of the respective semitrailer. The communication interface 303 is designed for example as an Ethernet, CAN, K-line, LIN or FlexRay interface. It is for example configured for wired communication with one or more vehicle sensors 305 and optional additional sensors 306 of the respective semitrailer via an Ethernet network or a CAN, K-line, LIN or FlexRay bus system of the respective semitrailer. By way of example, the telematics unit 3 may transmit pieces of information to the vehicle sensors 305 and/or additional sensors 306 and/or receive said pieces of information therefrom via the wired communication interface 303. As disclosed above, Ethernet is specified for example in the standards of the IEEE 802.3 family. CAN is specified in the standards of the ISO 11898 family, K-line is specified in the ISO 9141 and ISO 14230-1 standards, LIN is specified in the standards of the ISO 17987 family and FlexRay is specified in the standards of the ISO 17458 family.

In FIG. 3, the sensors 305 and 306 are not illustrated as part of the telematics unit 3. However, it goes without saying that the sensors 305 and 306 may also be part of the telematics unit as a whole or in part.

Examples of the vehicle sensors 305 and/or the additional sensors 306 are a temperature sensor and/or a battery sensor and/or a voltage sensor and/or a current sensor and/or a door sensor and/or a tank fill level sensor and/or a tire pressure sensor and/or a weight sensor. It goes without saying that the vehicle sensors 305 and/or the additional sensors 306 are not limited to these sensor types.

The vehicle sensors 305 and/or the additional sensors 306 may be part of the respective semitrailer at least in part.

The telematics unit 3 furthermore has a wireless communication interface 304 controlled by the processor 300 and via which pieces of information are able to be exchanged (for example transmitted and/or received) with a remote device, such as the server 2 in the system illustrated in FIG. 1, via a wireless communication path. The wireless communication interface 304 is designed for example as a WLAN and/or mobile telephony interface. WLAN, as disclosed above, is standardized in the standards of the IEEE 802.11 family. Mobile telephony should be understood to mean in particular mobile telephony communication systems such as a 2G/3G/4G/5G/6G communication system. The specifications of the 2G, 3G, 4G, 5G or 6G mobile telephony communication systems are currently developed by the 3rd Generation Partnership Project (3GPP) and are currently available on the Internet at https://www.3gpp.org/.

The components 300 to 304 of the telematics unit 3 are for example communicatively and/or operatively connected to one another via one or more bus systems (for example one or more serial and/or parallel bus connections).

It goes without saying that the telematics unit 3 may comprise further components (for example a user interface) in addition to the illustrated components.

FIG. 4 shows a flowchart 400 of one exemplary embodiment of a method according to the invention. It will be assumed by way of example below that the method is performed by the server 2, which is part of the system 1 illustrated in FIG. 1.

In a step 401, a digital representation of a vehicle is held. In this case, holding a digital representation of a vehicle should be understood to mean for example that such a digital representation is stored in a memory of the server 2.

As disclosed above, the program memory 201 contains a respective digital representation for each of the semitrailers 101, 102 and 103 of the system 1 illustrated in FIG. 1. Each of the digital representations should be understood below as a digital model, a digital twin as it is known, of the respective semitrailer. Each digital twin represents for example the basic state and the operating state of the respective semitrailer.

As disclosed in detail above, the basic state of the respective semitrailer should be understood to mean for example a description (for example a representation) of (for example selected) characteristics of the vehicle that typically do not change during operation of the vehicle. By way of example, the basic state may essentially describe the unchangeable characteristics of the respective semitrailer resulting from the configuration and/or production of the respective semitrailer. These are for example technical data concerning the respective semitrailer (such as tank capacity, battery capacity, tire size and/or vehicle weight) and/or operating points of the respective semitrailer (such as target battery voltage, maximum battery temperature, target tire pressure and/or maximum axle load). It will be assumed by way of example below that the semitrailers 101, 102 and 103 of the system 1 have the same configuration and that their digital twins each represent the same basic state.

As disclosed in detail above, the operating state of the respective semitrailer should be understood to mean for example a description (for example a representation) of (for example selected) characteristics of the vehicle that typically change during operation of the vehicle. Such changeable characteristics are determined for example by the use of the respective semitrailer and/or the consumption of resources during operation of the respective semitrailer. These are for example characteristics monitored by vehicle sensors during operation of the vehicle (such as tank fill level, battery voltage, battery temperature, tire pressure and/or axle load). It will be assumed by way of example below that the current operating state of the respective semitrailer is represented by the last telematics dataset transmitted by the telematics unit of the respective semitrailer (for example represented by the sensor data contained therein).

In a step 402, a first sensor dataset is received, wherein the first sensor dataset comprises sensor data that have been recorded by vehicle sensors of the vehicle, and wherein the first sensor dataset represents a first state of the vehicle.

By way of example, in step 401, the server 2 receives a first telematics dataset containing the first sensor dataset from the telematics unit 3-1 of the semitrailer 101 via the communication path 107. The sensor data of the first sensor dataset were accordingly recorded by the vehicle sensors of the semitrailer 101, and represent the current operating state (that is to say, in this example, the first state) of the semitrailer 101.

In a step 403, the digital representation of the vehicle is updated based on the first sensor dataset in order to obtain an updated digital representation of the vehicle in the first state.

By way of example, in step 403, the server 2 may update the digital twin of the semitrailer 101 based on the first sensor dataset contained in the first telematics dataset received in step 401, such that the updated digital twin represents the semitrailer 101 in the current operating state (that is to say, in this example, the first state). By way of example, the updated digital twin may contain the first sensor dataset contained in the first telematics dataset.

In a step 404, based on the updated digital representation of the vehicle, an unknown and/or undesirable behavior of the vehicle and/or of one or more components of the vehicle is detected.

By way of example, in step 404, the server is able to detect an unknown and/or undesirable behavior of the semitrailer 101 and/or of one or more components of the semitrailer based on the digital twin updated in step 403.

By way of example, as disclosed in detail above, the detection in step 404 may be carried out based on predefined rules. However, it will be assumed by way of example below that the detection in step 404 is carried out based on a detection model obtained by machine learning in the form of an artificial neural network. The detection model, as disclosed above, is stored in the program memory 201 of the server 2 and is trained by machine learning to detect an unknown and/or undesirable behavior of a semitrailer (for example of the semitrailer 101) and/or of one or more components of the semitrailer (for example of the semitrailer 101) based on an updated digital twin of the semitrailer (for example the digital twin of the semitrailer 101 updated in step 403).

The detection model in the form of the artificial neural network comprises at least three layers, including the input layer and the output layer. Examples of such an artificial neural network are neural networks having a feedforward architecture, multilayer perceptrons, convolutional neural networks and/or recurrent neural networks.

The fact that the detection in step 404 is carried out based on the updated digital twin should be understood to mean for example that the detection model receives the updated digital twin of the semitrailer 101 and/or the first sensor dataset contained therein as input data in step 404. As a result, the detection model outputs output data indicating whether an unknown and/or undesirable behavior (or for example a known and/or desirable behavior) of the semitrailer 101 has been detected.

By way of example, the detection model is trained as part of supervised learning. In supervised learning, the detection model is trained, for example with training datasets, with it being specified, for each training dataset, whether an unknown and/or undesirable behavior (or for example a known and/or desirable behavior) is to be detected for the respective training dataset. By way of example, each of the training datasets comprises, as disclosed in detail above, respective sensor data that were recorded by one or more of the vehicle sensors and/or by one or more additional sensors of a training vehicle, wherein each of the training datasets represents a respective state (for example an operating state such as a known and/or desirable operating state or an unknown and/or undesirable operating state) of the respective training vehicle. If a training dataset represents for example a known and/or desirable operating state, it is specified for example that the detection model should detect a known and/or desirable behavior for the training dataset; and if a training dataset represents for example an unknown and/or undesirable operating state, it is specified for example that the detection model should detect an unknown and/or undesirable behavior for the training dataset.

In response to the detection of the unknown and/or undesirable behavior in step 404, at least one of steps 405 and 406 described below is performed. It goes without saying that both steps 405 and 406 may also be performed in response to the detection of the unknown and/or undesirable behavior in step 404. If, on the other hand, no unknown and/or undesirable behavior has been detected, the flowchart 400 ends or restarts.

In a step 405, detection information to the effect that an unknown and/or undesirable behavior has been detected is generated. The detection information is for example user information used to inform a user that an unknown and/or undesirable behavior has been detected. By way of example, the detection information is based on an output from the detection model.

By way of example, in step 405, user information is generated as detection information to the effect that an unknown and/or undesirable behavior of the semitrailer 101 has been detected. The server 2 is able to transmit the user information to the user device 110 via the communication path 111. The user device 110 may then output the user information to the user supervising the fleet comprising the semitrailers 101, 102 and 103, to inform them that an unknown and/or undesirable behavior has been detected.

In a step 406, a program code for detecting the unknown and/or undesirable behavior is generated by a data processing unit of the vehicle. By way of example, the generation of the program code is based on an output from the detection model. By way of example, the detection model may output at least part of the program code or a representation of at least part of the program code. By way of example, the detection model may output instructions in a higher programming language such as C++ or Java. These instructions in the higher programming language may represent the program code or part of the program code in the form of a source code. These instructions may then be combined and/or compiled with other instructions in the higher programming language as part of generating the program code, in order to generate the program code in the form of machine code.

By way of example, the program code generated in step 406 may comprise instructions of a computer program able to be executed by the processor of the telematics unit 3-1 of the semitrailer 101 and/or part of a computer program able to be executed by the processor of the telematics unit 3-1 of the semitrailer 101. The computer program may for example be a diagnostic program able to be executed by the processor of the telematics unit 3-1 of the semitrailer 101 and/or part of such a diagnostic program.

The program code generated in step 406 contains for example instructions that cause the processor of the telematics unit 3-1 of the semitrailer 101, when it executes the instructions, to detect the unknown and/or undesirable behavior based on sensor data recorded by vehicle sensors of the semitrailer 101.

The server 2 may transmit the program code generated in step 406 via the communication path 107 in the form of an update for the diagnostic program, which is stored in the program memory of the telematics unit 3-1 of the semitrailer 101. The update adds the instructions of the program code to the diagnostic program, for example, in such a way that the instructions of the diagnostic program cause the processor of the telematics unit 3-1 of the semitrailer 101, when it executes the instructions, to detect the unknown and/or undesirable behavior when the telematics unit 3-1 receives sensor data of a second sensor dataset, which correspond at least substantially to the sensor data of the first sensor dataset, via the wired communication interface 303. If the processor of the telematics unit 3-1 of the semitrailer detects the unknown and/or undesirable behavior, the instructions may furthermore cause the processor, when it executes the instructions, to add a fault code assigned to the unknown and/or undesirable behavior to the next telematics dataset that is transmitted to the server 2.

The exemplary embodiments of the present invention that are described in this specification should also be understood as being disclosed in all combinations with one another. In particular, the description of a feature that an embodiment comprises should also not—unless explicitly stated to the contrary—be understood in the present case to mean that the feature is indispensable or essential for the function of the exemplary embodiment. The sequence of the steps described in this specification in the individual flowcharts is not mandatory; alternative sequences of the steps are conceivable—unless otherwise specified. The steps may be implemented in various ways, with software implementation (by program instructions), hardware implementation or a combination of both to implement the steps being conceivable.

Terms used in the claims such as “comprise”, “have”, “contain”, “include” and the like do not exclude further elements or steps. The wording “at least partially” encompasses both the “partially” case and the “completely” case. The wording “and/or” should be understood to the effect that both the alternative and the combination are intended to be disclosed, that is to say that “A and/or B” means “(A) or (B) or (A and B)”. In the context of this specification, a plurality of units, persons or the like means multiple units, persons or the like. The use of the indefinite article does not exclude a plurality. A single component may perform the functions of several units or devices specified in the claims. The references given in the claims are not to be regarded as restrictions on the means and steps used.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method performed by one or more servers, wherein the method comprises:
holding a digital representation of a vehicle;
receiving a first sensor dataset, wherein the first sensor dataset comprises sensor data that have been recorded by vehicle sensors of the vehicle, and wherein the first sensor dataset represents a first state of the vehicle;
updating the digital representation of the vehicle based on the first sensor dataset in order to obtain an updated digital representation of the vehicle in the first state;
detecting, based on the updated digital representation of the vehicle, at least one of an unknown and/or undesirable behavior of the vehicle or of one or more components of the vehicle;
in response to detecting the unknown and/or undesirable behavior at least one of:
generating detection information to the effect that an unknown and/or undesirable behavior has been detected; or
generating a program code for detecting the unknown and/or undesirable behavior by way of a data processing unit of the vehicle.

2. The method as claimed in claim 1, wherein the method furthermore comprises at least one of the following steps:
at least one of (i) outputting or causing the output of the detection information to a user or (ii) outputting or causing the output of the detection information for further processing;
providing the detection information for output to a user;
outputting and/or providing the detection information for further processing;
transmitting the program code to the vehicle or a plurality of vehicles;
providing the program code for retrieval by the vehicle or a plurality of vehicles.

2. (canceled)

3. The method as claimed of claim 1, wherein the unknown and/or undesirable behavior is detected based on a detection model obtained by machine learning.

4. The method as claimed in claim 3, wherein the detection model is trained as part of supervised learning.

5. The method of claim 3, wherein the method furthermore comprises:
training the detection model with training datasets, wherein each of the training datasets comprises respective sensor data that were recorded by the vehicle sensors and by additional sensors of a training vehicle, and wherein each of the training datasets represents a respective state of the respective training vehicle.

6. The method as claimed in claim 5, wherein at least one of the training datasets comprises at least sensor data from one or more additional sensors different from the vehicle sensors.

7. The method of claim 3, wherein the detection model receives the updated digital representation of the vehicle as input data, and/or wherein the detection model outputs a representation of the unexpected behavior.

8. The method of claim 3, wherein the generation of the program code is based on an output from the detection model, and/or wherein the detection model outputs a representation of at least part of the program code.

9. The method of claim 1, wherein the program code is configured to cause the data processing unit of the vehicle to detect the unknown state at least when the data processing unit receives a second sensor dataset, wherein the second sensor dataset comprises sensor data that were recorded by vehicle sensors of the vehicle, and wherein the sensor data of the second sensor dataset correspond at least substantially to the sensor data of the first dataset.

10. The method of claim 1, wherein the unknown and/or undesirable behavior is associated with an unknown fault state of the vehicle or the one or more components of the vehicle.

11. The method of claim 10, wherein the method furthermore comprises:
assigning a fault code to the unknown and/or undesirable behavior.

12. The method of claim 1, wherein the vehicle is a utility vehicle trailer.

13. A computer program comprising program instructions that are designed, when they are executed by at least one processor of a server, to cause the server to perform the following method alone or in cooperation with one or more further servers:
holding a digital representation of a vehicle;
receiving a first sensor dataset, wherein the first sensor dataset comprises sensor data that have been recorded by vehicle sensors of the vehicle, and wherein the first sensor dataset represents a first state of the vehicle;
updating the digital representation of the vehicle based on the first sensor dataset in order to obtain an updated digital representation of the vehicle in the first state;
detecting, based on the updated digital representation of the vehicle, at least one of an unknown and/or undesirable behavior of the vehicle or of one or more components of the vehicle;
in response to detecting the unknown and/or undesirable behavior at least one of:
generating detection information to the effect that an unknown and/or undesirable behavior has been detected; or
generating a program code for detecting the unknown and/or undesirable behavior by way of a data processing unit of the vehicle.

14. A server comprising at least one processor and at least one memory containing program instructions, wherein the at least one memory and the program instructions are configured, together with the at least one processor, to cause the server to perform the following alone or in cooperation with one or more further servers:
holding a digital representation of a vehicle;
receiving a first sensor dataset, wherein the first sensor dataset comprises sensor data that have been recorded by vehicle sensors of the vehicle, and wherein the first sensor dataset represents a first state of the vehicle;
updating the digital representation of the vehicle based on the first sensor dataset in order to obtain an updated digital representation of the vehicle in the first state;
detecting, based on the updated digital representation of the vehicle, at least one of an unknown and/or undesirable behavior of the vehicle or of one or more components of the vehicle;
in response to detecting the unknown and/or undesirable behavior at least one of:
generating detection information to the effect that an unknown and/or undesirable behavior has been detected; or
generating a program code for detecting the unknown and/or undesirable behavior by way of a data processing unit of the vehicle.

15. (canceled)

16. The server as claimed in claim 14, wherein the unknown and/or undesirable behavior is detected based on a detection model obtained by machine learning.

17. The server as claimed in claim 16, wherein the at least one memory and the program instructions are furthermore configured, together with the at least one processor, to cause the server to perform the following alone or in cooperation with the one or more further servers:
training the detection model with training datasets, wherein each of the training datasets comprises respective sensor data that were recorded by the vehicle sensors and by additional sensors of a training vehicle, and wherein each of the training datasets represents a respective state of the respective training vehicle.

18. The server as claimed in claim 16, wherein the detection model receives the updated digital representation of the vehicle as input data, and/or wherein the detection model outputs a representation of the unexpected behavior.

19. The server as claimed in claim 16, wherein the generation of the program code is based on an output from the detection model, and/or wherein the detection model outputs a representation of at least part of the program code.

20. The server as claimed in claim 14, wherein the program code is configured to cause the data processing unit of the vehicle to detect the unknown state at least when the data processing unit receives a second sensor dataset, wherein the second sensor dataset comprises sensor data that were recorded by vehicle sensors of the vehicle, and wherein the sensor data of the second sensor dataset correspond at least substantially to the sensor data of the first dataset.

21. The server as claimed in claim 14, wherein the unknown and/or undesirable behavior is associated with an unknown fault state of at least one of the vehicle or of the one or more components of the vehicle, and wherein the at least one memory and the program instructions are furthermore configured, together with the at least one processor, to cause the server to perform the following alone or in cooperation with the one or more further servers:
assigning a fault code to the unknown and/or undesirable behavior.

22. The method as claimed in claim 1, wherein the first sensor dataset comprises at least sensor data from one or more vehicle sensors of the following vehicle sensor types:
temperature sensor;
battery sensor;
voltage sensor;
current sensor;
door sensor;
tank fill level sensor;
tire pressure sensor;
weight sensor.
